(19) United States
(12) Patent Application Publication
(10) Pub. No.: US 2006/0123408 A1
(43) Pub. Date: Jun. 8, 2006

(54) Method and system for managing online applications

(76) Inventor: Luc Martin, Quebec (CA)

Correspondence Address: Jeffrey S Sokol;Cook & Franke, 660 E Mason Street, Milwaukee, WI, 53202, US

(21) Appl. No.: 10/559,487

(22) PCT Filed: Jun. 4, 2004
(86) PCT No.: PCT/CA04/00817

§ 371 Date: Dec. 6, 2005

(30) Foreign Application Priority Data
Jun. 6, 2003 (CA) 2431454

(51) Int. Cl. G06F 9/44; G06F 9/445

(52) U.S. Cl. 717/169; 717/175; 717/121; 717/120

(57) ABSTRACT

A system and method for managing an online software application, which includes an online user manual integrally bundled with the online software application, the user manual providing one or more supporting tools to enable the online, real-time management and distribution of the online software application. The supporting tools include tools such as a personalization module, a statistics module, an access channel tools module, a licensing module, an authentication module, and other tools or modules as necessary for managing the online software application during its complete lifecycle.

### FIELD OF THE INVENTION

The present invention relates generally to managing and distributing online applications, and more particularly, to a method and system to enable the online, real-time management and distribution of online applications.

### BACKGROUND OF THE INVENTION

A “desktop” software application is one that a user purchases in a computer store, or downloads via a global computer network (e.g. the Internet), and installs on his or her own computer or on a local area network (“LAN”). The desktop application is loaded into memory from the person's own computer hard drive or LAN server each time the user wishes to use the application.

One problem with such desktop applications is that they quickly become outdated as new versions are written and become available. As a result, to obtain the latest improvements, the user must continue to purchase and install upgraded versions. Another problem is that they can be expensive to own, and the cost may not be justified if one is not a heavy user of the application.

To avoid these problems, there is an increasing trend in the computer industry away-from such desktop software applications towards what will be referred to here as “online” software applications. An online software application does not reside on the user's hard drive or on a LAN server, but instead resides on a Web server connected to a global computer network and accessed via a Web page. A Web browser such as Microsoft's Internet Explorer™ or Netscape's Navigator™, can be used to access the Web page. The Web page provides a button or link, which can be “clicked” to provide access to the online application or, in the alternative, the application can be directly imbedded in the Web page.

One problem with such online software applications is that they do not inherently contain any means by which the application owner can manage the application, which resides on a remote server. For example, an online software application is designed to perform a particular function, such as run an e-commerce Web site (shopping cart) or an online discussion forum, but inherently contains no features to permit the owner to personalize the application for a particular use or facilitate, control, monitor and manage access, distribution or use of the software application in an online environment. Currently, online applications must be individually customized and managed for each owner. These tasks are normally performed manually by the owner, manually by the service provider or host of the online application on behalf of the owner, or by the owner through a modification interface located and maintained on the service provider or host portal/Web site. The manual modifications noted above are costly to undertake, while using the modification interface requires the online application owner to access and logon to the host or service provider portal/Web site. One other problem associated with linking the customization and management of the online application to the host or service provider Web site is that it inhibits third party sale and distribution of the online application.

Accordingly, there is a need to provide an improved system for managing and controlling such online applications that solves these inherent problems.

### SUMMARY OF THE INVENTION

In view of the foregoing, an object of one aspect of the present invention is to provide a system for managing online software applications.

According to one aspect of the present invention then, there is provided, a system for managing an online software application comprising: an online user manual providing one or more supporting tools adapted to enable online management of the online software application; and a bundling application integrally bundling the online user manual with the online software application.

According to another aspect of the present invention there is provided a method for managing an online software application comprising the steps of using a bundling application to bundle an online user manual with the online software application, the online user manual providing one or more supporting tools adapted to enable online management of the online software application.

In further aspects of the invention, the user manual supporting tools may include a personalization module for editing and updating the configuration parameters of the online software application, a user statistics module for recording and displaying information relating to usage of the online software application, an owner statistics module for recording and displaying information relating to usage of the user manual and bundling application, a user access channel tools module for setting up user access channels used by a user of the online software application to gain access to the online software application, an owner access channel tools module for setting up owner access channels used by an owner of the online software application to gain access to the user manual and bundling application, a licensing module for setting up and managing the terms of use of the online software application, the user manual and the bundling application, or an authentication module for configuring and controlling access to the user manual, the bundling application and/or the online software application.

In yet another aspect of the invention, the user manual is adapted to enable the online management of the online software application in real-time.

Advantageously, the present system provides the necessary supporting tools and information for an online application owner to manage an online application during its complete lifecycle, including customization, use, distribution, access, and control.

### BRIEF DESCRIPTION OF THE DRAWINGS

The present invention will be further understood from the following description of preferred embodiments with reference to the drawings in which:

FIG. 1 is a representation of a Web page.

FIG. 2 is diagram showing a Web user using a Web browser to access the Web page of FIG. 1.

FIG. 3 is a representation of an online application.

FIG. 4 is a diagram showing a Web user using a Web browser to access the online application of FIG. 3.

FIG. 5 is a representation of user manual for managing a managed online application.

FIG. 6 is a representation of a packaged online application comprising the managed application and the user manual of FIG. 5, and the bundling application.

FIG. 7 is a diagram showing a packaged application owner accessing the packaged application and a packaged application user accessing the managed application.

FIG. 8 is a diagram showing a packaged application owner and a packaged application user using access channels to access the packaged application and the managed application.

FIG. 9 is a representation of some of the possible modules contained within the user manual.

FIG. 10 is a representation of a personalization module.

FIG. 11 is a representation of a statistics module.

FIG. 12 is a representation of an access channel tools module.

FIG. 13 is a representation of a licensing module.

FIG. 14 is a representation of an authentication module.

Similar reference numerals are used in different figures to denote similar components.

### DETAILED DESCRIPTION OF THE PREFERRED EMBODIMENT

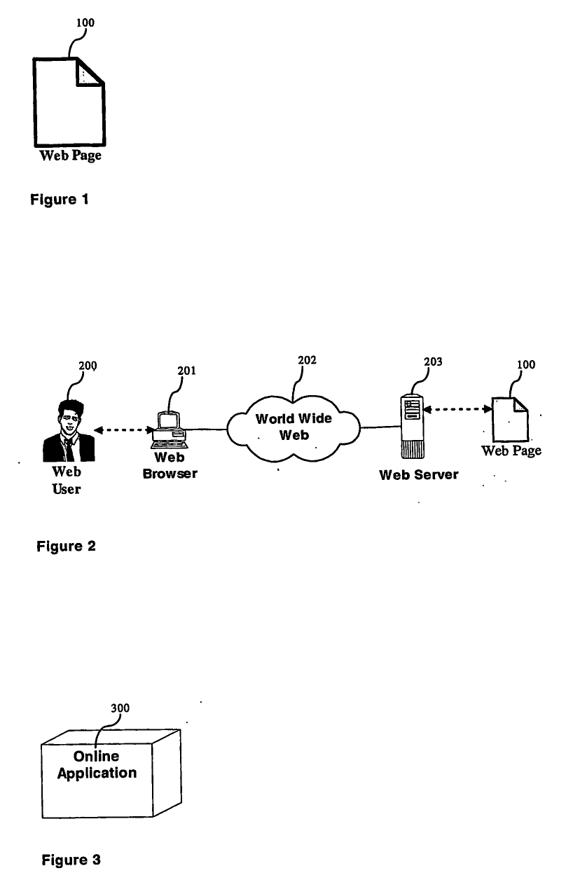

Referring to FIGS. 1 and 2, a Web page 100 is a single page visual document retrievable on a World Wide Web 202, which is part of a global computer network (for example, the Internet). Web page 100 is defined by computer instructions, or code, rendered by a Web browser 201 such as Microsoft's Internet Explorer™ or Netscape's Navigator™. The computer code may be HTML, Javascript™, JPEG, GIF, Java™ Applets or the like. A Web user 200 navigates on the World Wide Web 202 using browser 201 and accesses Web page 100 located on a Web server 203. For each request made by Web user 200, Web browser 201 sends an HTTP request to Web server 203, which returns one Web page 100.

Referring to FIG. 3, an online application 300 is a software program accessible via World Wide Web 202. Online application 300 is composed of one or more logically interlinked Web pages. 100, which provide a specific function. Online application 300 can be implemented using server-side technologies such as Java™ Server Pages (JSP), Microsoft Active Server Pages (ASP), Common Gateway Interface (CGI), and others. Online application 300 can range from a simple content (or information) presentation to a highly sophisticated, transactional, session-based and interactive program. A Web site may be considered an online application 300. Online application 300 usually includes the complete logic and data to perform a specific task, for example e-commerce (shopping cart), discussion forum, sports pool, etc. Online application 300 may be developed in a generic manner so that it can be used in multiple situations.

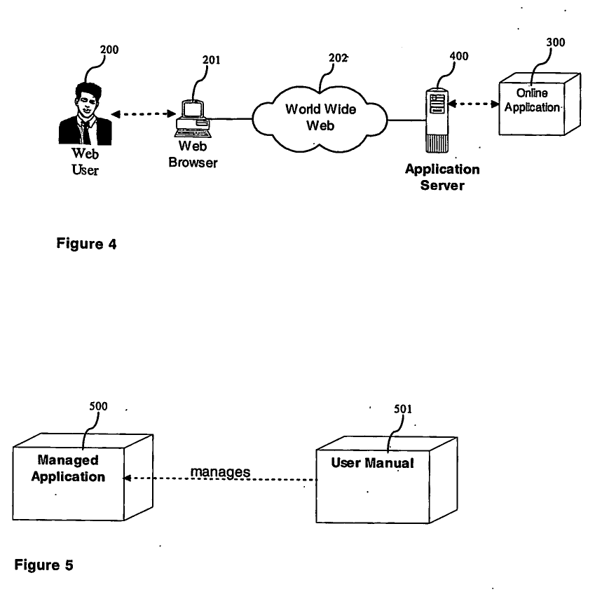

Referring to FIG. 4, online application 300 may be located on an application server 400, which is a Web server 203 that supports server-side technologies. Online application 300 is accessed by Web user 200 via World Wide Web 202, using Web browser 201. Application server 400′ serves both Web pages 100 and online applications 300 and may host one or more online applications 300. Web user 200 accesses individual Web pages 100, which are part of online applications 300. Web pages 100 accessed by Web user 200 may be from one or more online applications 300 located on one or more application servers 400.

Online applications 300 need to be managed (that is personalized, monitored, upgraded, etc.) by their owners during their life cycles. Referring to FIG. 5, any online application 300 that is managed in this way by its owner is referred to as a managed application 500. Currently, the management of managed application 500 is conducted manually on an individual case-by-case basis by the owner of the application or by the host or service provider on behalf of the owner. Managed application 500 may also be managed by the owner through a special modification interface located and maintained separately on the Web site of the host or service provider.

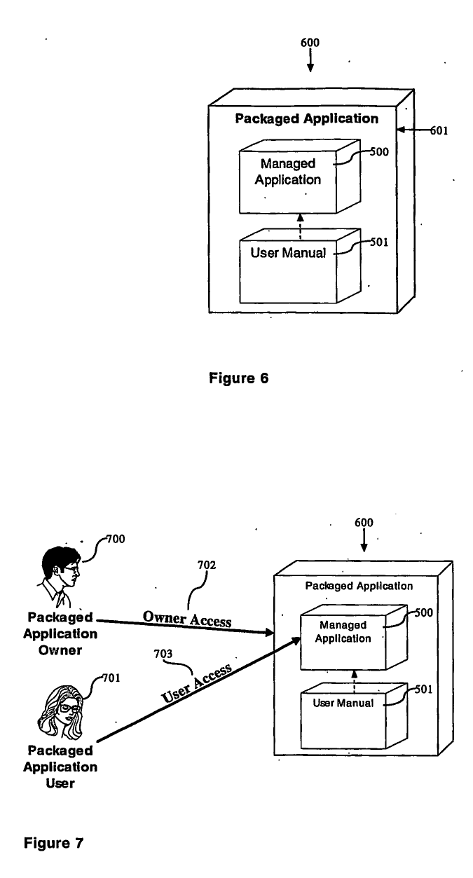

Referring to FIG. 6, management of managed application 500 in accordance with the present invention is accomplished by integrally packaging or bundling a user manual 501 with managed application 500. User manual 501 is an online application 300 that enables the online and real-time management of managed application 500. User manual 501 is integrally packaged or bundled with managed application 500 using a packaging or bundling software application 601, thus creating a packaged or bundled application 600. Packaging software application 601 may be an online application. Packaged application 600 includes managed application 500, its associated online user manual 501, and packaging or bundling application 601, to result in a complete, integrally packaged or bundled online product. Packaged application 600 includes, in a single package, all of the supporting tools required to enable the use, personalization, management, control and distribution of managed application 500.

Referring to FIG. 7, a packaged application owner 700 is a Web user 200 who owns packaged application 600. Owner 700 may be the developer and creator of managed application 500 but more likely is someone who has purchased the rights to managed application 500 from a third party. Owner 700 has owner access 702 to the complete packaged application 600, including managed application 500, packaging application 601, and user manual 501. A packaged application user 701 is a Web user 200 that is only allowed to access the managed application 500 portion of packaged application 600. User 701 has user access 703, but has no access to user manual 501, or packaging application 601, and has no application management privileges. For each packaged application 600 there can be only one owner 700, which may be an individual or a company comprised of many individuals. Packaged application 600 can have zero or more users 701. In some situations, owner 700 may also be one of the users 701.

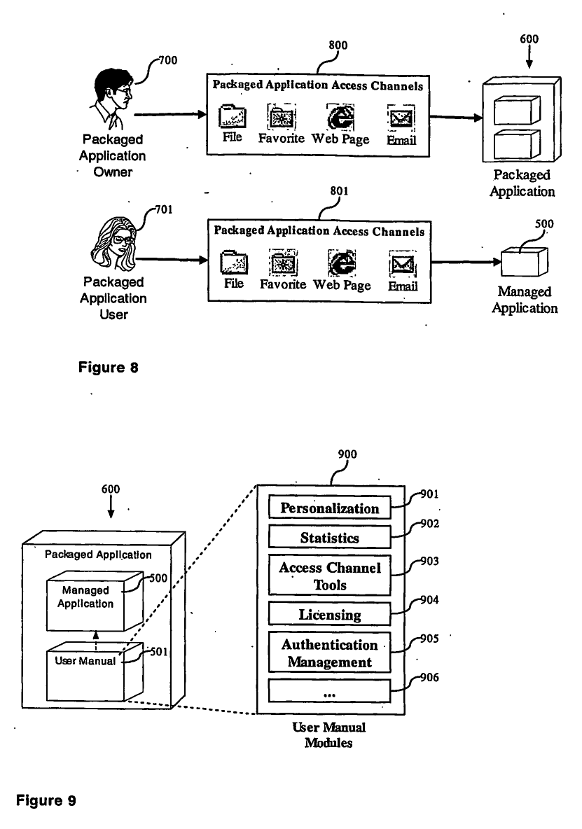

To access packaged application 600, comprising the managed application 500, packaging application 601, and user manual 501, owner 700 types a uniform resource locator (URL) into the location bar of his or her Web browser 201. As shown in FIG. 8, owner 700 may also use owner access channels 800 to access packaged application 600. Users 701 may use either a URL typed into the location bar of Web browser 201 or user access channels 801 to access managed application 500. Access channels 800, 801 use files, favorites, Web pages and e-mails to provide owner 700 and user 701 easy access to packaged application 600 and managed application 500, respectively.

The role of user manual 501 is to provide all the necessary tools and information to packaged application owner 700 to permit the complete online, real-time management of the lifecycle of managed application 500. As shown in FIG. 9, user manual 501 includes user manual modules 900, to provide the necessary management functions. User manual modules 900 include a personalization module 901, a statistics module 902, an access channel tools module 903, a licensing module 904, and an authentication management module 905. One skilled in the art will appreciate that other modules 906 may also be included as necessary for the management of managed application 500.

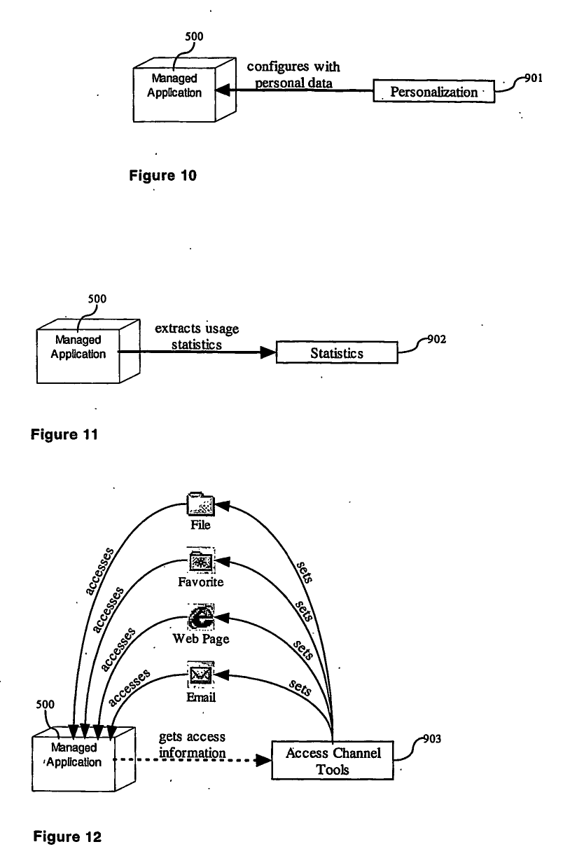

Referring to FIG. 10, personalization module 901 allows packaged application owner 700 to edit and update the configuration parameters of managed application 500 to configure managed application 500 with personal data for a particular application. For example, in an e-commerce application such as a shopping cart, the owner can change and update the various items available for sale and their prices. Once personalized, managed application 500 can be used by users 701, accessing the latest version.

Referring to FIG. 11, statistics module 902 includes a user statistics module that records and displays information on how managed application 500 is used by users 701. For example, number of hits, time of access, location of user, type of browser used, etc. Statistics module 902 may also include an owner statistics module to record statistics on how packaged application 600, including user manual 501 and packaging application 601, is used by owner 700, particularly if this role is being assumed by several different individuals within a company.

Referring to FIGS. 8 and 12, access channel tools module 903 includes a user access channel tools module, which provides all the tools necessary to set up user access channels 801 for easy access to managed application 500. The user access channel tools module is used to set up the corresponding user access channels (for example, files, favorites, Web page, or email) with the necessary information to access managed application 500 when user 701 requests access. Access channel tools module 903 may also include an owner access channel tools module to set up owner access channels 800 for accessing packaged application 600 by owner 700.

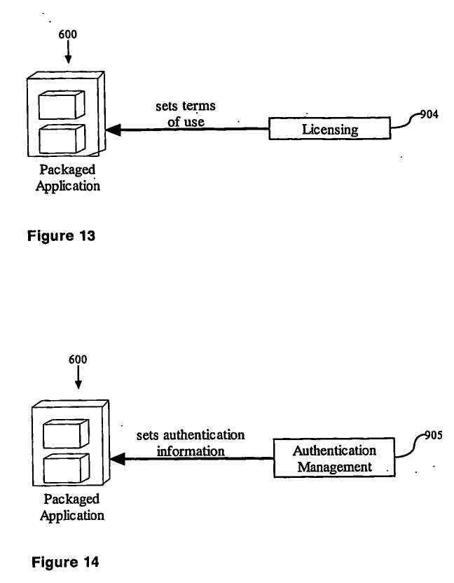

Referring to FIG. 13, licensing module 904 sets and manages the terms of use of packaged application 600, including managed-application 500, user manual 501, and packaging application 601. Packaged application 600 can be offered as a service by a third party, such as a service provider. Licensing module 904 is a service agreement between this third party and packaged application owner 700. only owner 700 is allowed to have access to the complete packaged application 600, including managed application 500, its associated user manual 501, and packaging application 601. Referring to FIG. 14, authentication management module 905 configures the owner access to packaged application 600. This access may be protected by one or more usernames and passwords. Authentication management module 905 may also be used to control access to managed application 500 by users 701.

Those skilled in the art will readily appreciate that other user manual modules 900 may be developed and included with user manual 501 as and when the need arises to provide additional supporting tools to owner 700 for the management of managed application 500.

The invention may be embodied in other specific forms without departing from the spirit or essential characteristics thereof. The present embodiments are therefore to be considered as illustrative and not restrictive, the scope of the invention being indicated by the appended claims rather than by the foregoing description, and all changes that come within the meaning and range of equivalency of the claims are therefore intended to be embraced therein.

1. A system for managing an online software application comprising:
an online user manual providing one or more supporting tools adapted to enable online management of the online software application; and
a bundling application integrally bundling said online user manual with the online software application.

2. The system as described in claim 1, wherein said supporting tools comprise a personalization module adapted for editing and updating the configuration parameters of the online software application.

3. The system as described in claim 1, wherein said supporting tools comprise a user statistics module adapted for recording and displaying information relating to usage of the online software application.

4. The system as described in claim 1, wherein said supporting tools comprise an owner statistics module adapted for recording and displaying information relating to usage of said user manual and said bundling application.

5. The system as described in claim 1, wherein said supporting tools comprise a user access channel tools module adapted for setting up user access channels used by a user of the online software application to gain access to the online software application.

6. The system as described in claim 1, wherein said supporting tools comprise an owner access channel tools module adapted for setting up owner access channels used by an owner of the online software application to gain access to said user manual and said bundling application.

7. The system as described in claim 1, wherein said supporting tools comprise a licensing module adapted for setting up and managing the terms of use of the online software application, said user manual, and said bundling application.

8. The system as described in claim 1, wherein said supporting tools comprise an authentication module adapted for configuring and controlling access to said user manual and said bundling application.

9. The system as described in claim 8, wherein said authentication module is adapted for configuring and controlling access to the online software application.

10. The system as described in claim 1, wherein said user manual is adapted for enabling said online management of the online software application in real-time.

11. A method for managing an online software application comprising the steps of:
using a bundling application to integrally bundle an online user manual with the online software application, said online user manual providing one or more supporting tools adapted to enable online management of the online software application.

12. The method as described in claim 11, wherein said supporting tools comprise a personalization module adapted for editing and updating the configuration parameters of the online software application.

13. The method as described in claim 11, wherein said supporting tools comprise a user statistics module adapted for recording and displaying information relating to usage of the online software application.

14. The method as described in claim 11, wherein said supporting tools comprise an owner statistics module adapted for recording and displaying information relating to usage of said user manual and said bundling application.

15. The method as described in claim 11, wherein said supporting tools comprise a user access channel tools module adapted for setting up user access channels used by a user of the online software application to gain access to the online software application.

16. The method as described in claim 11, wherein said supporting tools comprise an owner access channel tools module adapted for setting up owner access channels used by an owner of the online software application to gain access to said user manual and said bundling application.

17. The method as described in claim 11, wherein said supporting tools comprise a licensing module adapted for setting up and managing the terms of use the online software application, said user manual and said bundling application.

18. The method as described in claim 11, wherein said supporting tools comprise an authentication module adapted for configuring and controlling access to said user manual and said bundling application.

19. The method as described in claim 18, wherein said authentication module is adapted for configuring and controlling access to the online software application.

20. The method as described in claim 11, wherein said user manual is adapted for enabling said online management of the online software application in real-time.
